(19) United States
(12) Patent Application Publication
(10) Pub. No.: US 2011/0187541 A1
(43) Pub. Date: Aug. 4, 2011

(54) AUDIBLE ALARM DEVICE AND FIRE ALARM SYSTEM INCLUDING THE SAME

(76) Inventor: Takahiro Noguchi, Tokyo (JP)

(21) Appl. No.: 13/012,518

(22) Filed: Jan. 24, 2011

(30) Foreign Application Priority Data
Jan. 29, 2010 (JP) 2010-018269
Jan. 29, 2010 (JP) 2010-018598

(51) Int. Cl. G08B 17/10; G08B 3/10

(52) U.S. Cl. 340/628; 340/384.6

(57) ABSTRACT

Provided is an audible alarm device including a piezoelectric buzzer, which is capable of suppressing wasted current consumption not contributing to increased sound pressure of the piezoelectric buzzer. The audible alarm device includes: a piezoelectric buzzer; a coil connected in parallel to the piezoelectric buzzer; a current limiting means for adjusting a current supply period for the piezoelectric buzzer and the coil, and limiting a current to the coil during current supply; and a control circuit for controlling on/off time of the current limiting means.

### CROSS-REFERENCE TO RELATED APPLICATIONS

This application claims priority under 35 U.S.C. §119 to Japanese Patent Application No. W2010-018269 filed Jan. 29, 2010, and Japanese Application No. JP2010-018598 filed Jan. 29, 2010, the entire contents of which are hereby incorporated by reference.

### FIELD OF THE INVENTION

The present invention relates to an audible alarm device for sounding a piezoelectric buzzer, and a fire alarm system including the audible alarm device.

### BACKGROUND OF THE INVENTION

Conventionally, there is known a drive method for a piezoelectric buzzer, with which the piezoelectric buzzer makes a sound by connecting a booster coil and a piezoelectric element, which are provided in parallel to each other, to an output terminal of a switching transistor (see, for example, Japanese Patent Application Laid-open No. Sho 57-210396 (page 2, FIG. 1)).

Further, there is known an alarm in which “a frequency of a voltage to be output to a piezoelectric buzzer is varied to vary a sound frequency of the piezoelectric buzzer” (see, for example, Japanese Patent Application Laid-open No. 2009-059137 (pages 2 and 5, FIG. 4).

In the technology described in Japanese Patent Application Laid-open No. Sho 57-210396, a voltage is applied to the coil so that energy is accumulated in the coil as magnetic energy, and then the energy accumulated in the coil is released, to thereby sound the piezoelectric buzzer. When the energy accumulated in the coil is released, a boosted voltage due to a counter electromotive voltage of the booster coil higher than the voltage applied to the coil is generated, and hence it is possible to increase sound pressure of the piezoelectric buzzer.

Meanwhile, the piezoelectric buzzer has a unique frequency, and if the piezoelectric buzzer is driven at a frequency shifted from the unique frequency, the sound pressure may reduce abruptly. In the technology described in Japanese Patent Application Laid-open No. 2009-059137, the drive frequency of the piezoelectric buzzer is varied, and hence even the piezoelectric buzzer having fluctuations in drive frequency may be caused to make a sound with high sound pressure at any of the timings. Further, current consumption is different depending on the drive frequency of the piezoelectric buzzer, but by sounding the piezoelectric buzzer at varying frequencies, the frequencies may include a frequency allowing the piezoelectric buzzer to make a sound with small current consumption, thereby reducing power consumption on average.

However, when the switching transistor as switching means is turned on to supply a current to the coil and accumulate energy therein, magnetic saturation occurs at a certain level of energy and the energy can no longer be accumulated. Therefore, even if the current is supplied to the coil after the magnetic saturation of the coil, the counter electromotive voltage of the coil cannot be increased to increase the buzzer sound pressure more than the timing of magnetic saturation of the coil. On the other hand, after the counter electromotive voltage of the coil no longer increases, the current still increases because of the characteristics of the coil so that current consumption increases. In other words, wasted current consumption not contributing to the increased sound pressure of the piezoelectric buzzer is generated. The overall power consumption of the piezoelectric buzzer is reduced by varying the drive frequency, but a peak of the current consumption is not changed. Therefore, it is necessary to use large-capacity power or a fuse with a larger capacity than optimum.

### SUMMARY OF THE INVENTION

The present invention has been made to solve the problems as described above, and it is an object thereof to provide an audible alarm device including a piezoelectric buzzer, which is capable of suppressing wasted current consumption not contributing to increased sound pressure of the piezoelectric buzzer, and also provide a fire alarm system including the audible alarm device.

Further, it is another object of the present invention to provide an audible alarm device capable of suppressing a peak of current consumption, and a fire alarm system including the audible alarm device.

An audible alarm device according to the present invention includes: a piezoelectric buzzer; a coil connected in parallel to the piezoelectric buzzer; switching means for adjusting a current supply period for the piezoelectric buzzer and the coil; control means for controlling on/off time of the switching means; and current limiting means for limiting a current to the coil, the current limiting means being connected in series to the coil and the piezoelectric buzzer, which are connected in parallel.

An audible alarm device according to the present invention includes: a piezoelectric buzzer; a coil connected in parallel to the piezoelectric buzzer; current limiting means for adjusting a current supply period for the piezoelectric buzzer and the coil, and limiting a current to the coil during current supply; and control means for controlling on/off time of the current limiting means.

Further, in the audible alarm device, the current limiting means is an emitter follower circuit including a transistor and a resistor connected to an emitter of the transistor.

In the audible alarm device according to the present invention, a frequency of an on/off operation for adjusting the current supply period for the coil is varied.

Further, in the audible alarm device, the frequency of the on/off operation is varied and a duty ratio thereof is also varied.

Still further, in the audible alarm device, the frequency of the on/off operation is varied and the duty ratio thereof is also varied so that the on time is kept constant.

An audible alarm device according to the present invention includes: a piezoelectric buzzer sounding circuit including: a piezoelectric buzzer; a coil connected in parallel to the piezoelectric buzzer; switching means for adjusting a current supply period for the piezoelectric buzzer and the coil; and control means for varying a frequency to control on/off operation of the switching means; and a capacitor connected in parallel to the piezoelectric buzzer sounding circuit.

The audible alarm device according to the present invention further includes current limiting means for limiting a current supplied to the piezoelectric buzzer sounding circuit and the capacitor.

Further, in the audible alarm device, a duty ratio of the on/off operation or adjusting the current supply period for the coil is varied.

Still further, in the audible alarm device, the duty ratio of the on/off operation for adjusting the current supply period for the coil is varied so that on time is kept constant.

A fire alarm system according to the present invention includes: a fire alarm control panel; and the above-mentioned audible alarm device, which is connected to the fire alarm control panel through a signal line as a path for signal communication, in which the audible alarm device makes a sound based on a control signal transmitted from the fire alarm control panel.

A fire alarm system according to the present invention includes: a fire alarm control panel; and a plurality of the above-mentioned audible alarm devices, which are connected to the fire alarm control panel through a signal line as a path for signal communication, in which the plurality of the audible alarm devices make sounds based on a control signal transmitted from the fire alarm control panel, intermittently in synchronization among the plurality of the audible alarm devices.

The audible alarm device according to the present invention includes the current limiting means for limiting the current to the coil. Therefore, it is possible to suppress a maximum value of wasted current not contributing to increased sound pressure of the piezoelectric buzzer.

In the audible alarm device according to the present invention, the current limiting means for adjusting the current supply period for the coil and limiting the current is constituted by the emitter follower circuit including the transistor and the resistor connected to the emitter of the transistor. Therefore, the audible alarm device can be manufactured with a simple circuit configuration at low cost.

In the audible alarm device according to the present invention, the frequency of the on/off operation for adjusting the current supply period for the coil is varied. In general, there are fluctuations in drive frequency of the piezoelectric buzzer for obtaining a maximum sound pressure from one individual to another. Accordingly, in order to sound the piezoelectric buzzer at the maximum sound pressure, the appropriate frequency adjustment needs to be performed at the individual level. In the audible alarm device according to the present invention, however, the frequency is varied, thereby allowing the piezoelectric buzzer to sound at the maximum sound pressure without the frequency adjustment at the individual level.

Further, in the audible alarm device according to the present invention, the frequency of the on/off operation for adjusting the current supply period for the coil is varied and the duty ratio thereof is also varied. Therefore, it is possible to shorten a time for supplying a current to the coil under low frequency driving, to thereby reduce the current consumption.

The audible alarm device according to the present invention includes the capacitor connected in parallel to the piezoelectric buzzer sounding circuit. Therefore, when the piezoelectric buzzer sounding circuit consumes a small current, a current can be accumulated in the capacitor, whereas when the piezoelectric buzzer sounding circuit consumes a large current, the current can be supplied to the piezoelectric buzzer sound circuit from the capacitor. Therefore, it is possible to suppress the peak of current consumption of the piezoelectric buzzer sounding circuit.

Further, the audible alarm device according to the present invention includes the current limiting means for limiting the current supplied to the piezoelectric buzzer sounding circuit and the capacitor, and hence it is possible to further suppress the peak of current consumption of the piezoelectric buzzer sounding circuit.

In the audible alarm device according to the present invention, the frequency of the on/off operation for adjusting the current supply period for the coil is varied, and the duty ratio of the on/off operation is varied. Therefore, it is possible to shorten a time for supplying a current to the coil under low frequency driving, to thereby reduce the current consumption.

### BRIEF DESCRIPTION OF THE DRAWINGS

In the accompanying drawings:

FIG. 1 is an overall configuration diagram of a fire alarm system including an audible alarm device according to a first embodiment of the present invention;

FIG. 2 is a block diagram of the fire alarm system according to the first embodiment;

FIG. 3 is a schematic diagram illustrating current limitation in the audible alarm device according to the first embodiment;

FIG. 4 is a graph illustrating examples of sound pressure and current consumption of a piezoelectric buzzer when a frequency applied to the piezoelectric buzzer is varied in the first embodiment;

FIG. 5 is a graph illustrating the examples of the sound pressure and the current consumption of the piezoelectric buzzer when the frequency applied to the piezoelectric buzzer is varied in the first embodiment;

FIG. 6 is a block diagram of the audible alarm device according to the first embodiment, illustrating a case where a PNP transistor is used as switching means;

FIG. 7 is a diagram illustrating switching waveforms and charge waveforms of a coil in an audible alarm device according to a second embodiment of the present invention;

FIG. 8 is a block diagram of a fire alarm system according to a third embodiment of the present invention;

FIG. 9 is a diagram illustrating transmission signal waveforms of a signal transmitted by a fire alarm control panel and a signal received by terminal equipment and the audible alarm device; and

FIG. 10 is a block, diagram of a fire alarm system according to a fourth embodiment of the present invention.

### DETAILED DESCRIPTION OF THE PREFERRED EMBODIMENTS

### First Embodiment

In a first embodiment, description is given of an example of the case where an audible alarm device according to the present invention is applied to a fire alarm system including a so-called R-type fire alarm control panel, which transmits/receives a transmission signal (pulse signal) and notifies the fire occurrence when receiving a fire signal or the like detected by a fire detector or the like.

### [Fire Alarm System]

### (Overall Configuration)

First, a fire alarm system in the first embodiment is described,

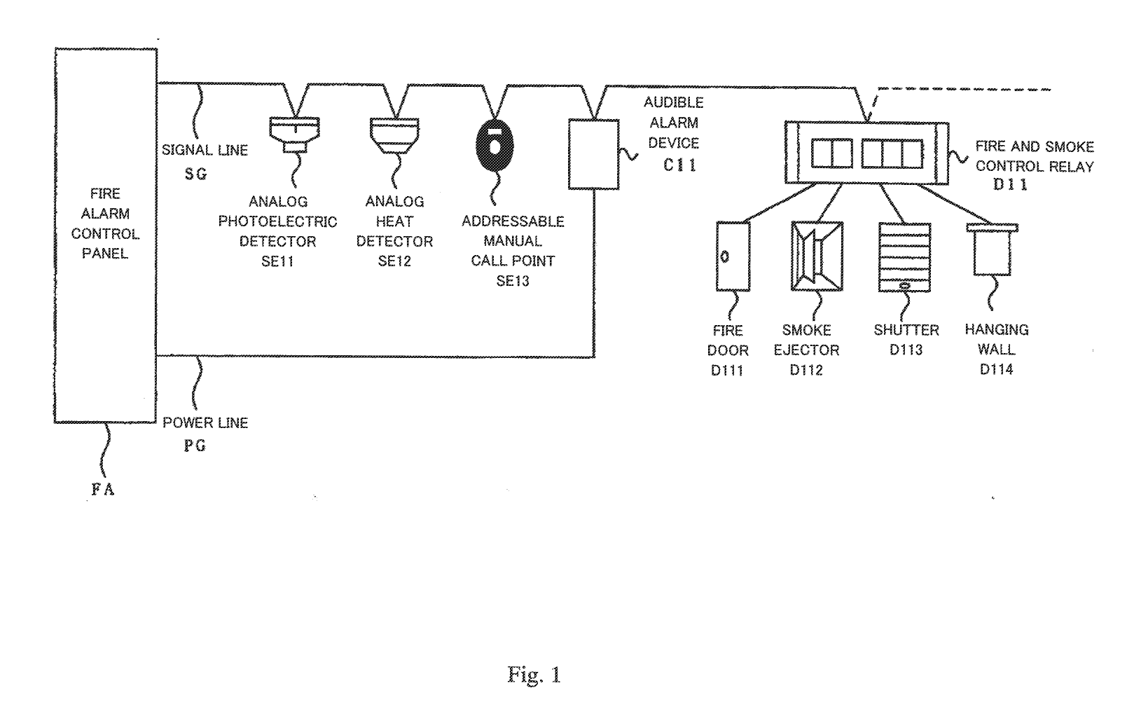

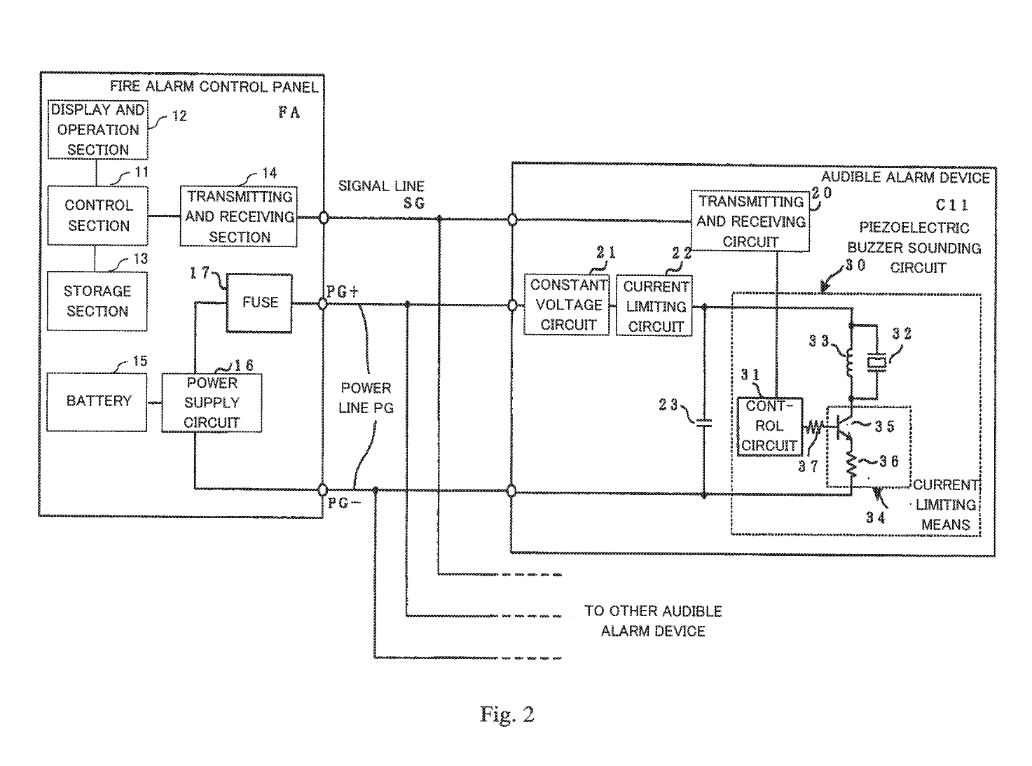

FIG. 1 is an overall configuration diagram of the fire alarm system according to the first embodiment. FIG. 2 is a configuration block diagram of the fire alarm system according to the first embodiment. A fire alarm control panel FA is connected to various types of terminal equipment through a signal line SG.

In FIG. 1, an analog photoelectric detector SE11, an analog heat detector SE12, an addressable manual call point SE13, an audible alarm device C11, and a fire and smoke control relay D11 are connected to the signal line SG. Note that, in the first embodiment, the equipment connected to the fire alarm control panel FA through the signal line SG may be collectively referred to as terminal equipment.

The analog photoelectric detector SE11 is a kind of smoke detector and transmits an analog value corresponding to detected smoke to the fire alarm control panel FA.

The analog heat detector SE12 is a kind of heat detector and transmits an analog value corresponding to a detected ambient temperature to the fire alarm control panel FA.

The addressable manual call point SE13 is a so-called fire manual call point, and includes a manually-operated push button for a person to discover a fire. When the push button is turned on, a fire signal is transmitted to the fire alarm control panel FA.

The audible alarm device C11 is the audible alarm device according to the present invention. The audible alarm device C11 makes a sound by a piezoelectric buzzer for notifying a fire in accordance with a control signal from the fire alarm control panel FA.

The audible alarm device C11 is connected to the fire alarm control panel FA through the signal line SG and also connected to the fire alarm control panel FA through a power line PG for power supply to drive the piezoelectric buzzer.

The fire and smoke control relay D11 is connected to fire and smoke control equipment, including a fire door D111, a smoke ejector D112, a shutter D113, and a hanging wall D114.

In FIG. 1, the above-mentioned fire and smoke control equipment as controlled equipment is connected one by one. Alternatively, a plurality of the fire and smoke control equipment may be connected, and other terminal equipment may be connected.

The terminal equipment connected to the signal line SG is communicated with the fire alarm control panel FA through the signal line SG and applied with power through the signal line SG.

### (Operation of Fire Alarm System)

Next, an example of an operation of the fire alarm system is described.

First, when smoke is detected by the analog photoelectric detector SE11 connected as the terminal equipment or when heat is detected by the analog heat detector SE12, detection information is transmitted as state information to the fire alarm control panel FA through the signal line SG.

The fire alarm control panel FA collects the state information transmitted from the analog photoelectric detector SE11 and the analog heat detector SE12. When the collected state information contains fire information (detection information exceeding a predetermined threshold), the fire alarm control panel FA transmits the control signal to the audible alarm device C11 so that the audible alarm device C11 makes a sound. In addition, at the time of fire occurrence, the fire alarm control panel FA transmits a control signal to the fire and smoke control relay D11 to operate the fire door D111, the smoke ejector D112, the shutter D113, and the hanging wall D114, to thereby prevent the spread of fire.

### (Communication Operation

Next, communications between the fire alarm control panel FA and the terminal equipment are described.

The fire alarm control panel FA communicates with the terminal equipment through a pulse signal which is a combination of a high-level voltage (V1H) and a low-level voltage (V1L).

### (1) Normal Communication Method

The fire alarm control panel FA communicates with the respective terminal equipment in order to collect the state information of the respective terminal equipment (see FIG. 1) connected to the signal line SG.

The fire alarm control panel FA may use the following three types of methods for the respective terminal equipment to collect the state information of the terminal equipment and to control the terminal equipment.

### (1-1) Point Polling

The fire alarm control panel FA transmits a state information request command to each group of a plurality of terminal equipment in order to collect the states of the plurality of connected terminal equipment. In contrast to this, each of the terminal equipment returns state information to the fire alarm control panel FA at a timing based on its own address in response to the state information request command. The fire alarm control panel FA repeats communication with each group to collect the state information of all the terminal equipment.

### (1-2) Selecting

The fire alarm control panel FA may specify an address corresponding to desired terminal equipment and transmit a predetermined control command to control the corresponding terminal equipment, or transmit, for example, the state information request command to desired terminal equipment to collect the state information from the terminal equipment. The terminal equipment having the specified address returns a control result to the fire alarm control panel FA in response to the control command or returns the requested state information,

### (1-3) System Polling

The fire alarm control panel FA may transmit a common control command to all the terminal equipment to control the respective terminal equipment. Examples of the control command in system polling include a fire recovery command (command for recovering, to normal monitoring state, detector or relay which has output the fire signal) and a zone alarming stop command (command for stopping audible alarm device C11 which is sounding),

### (2) Collection of Information of Abnormal State

When fire information is included in the state information collected from terminal equipment, for example, the analog photoelectric detector SE11 by point polling, the fire alarm control panel FA transmits a control signal for operation by selecting to the fire and smoke control relay D11 corresponding to the terminal equipment which has transmitted the fire information, based on a database stored in a storage section 13. In a case where the state information request command is transmitted by point polling to the terminal equipment registered in the database stored in the storage section 13 of the fire alarm control panel FA, when terminal equipment does not reply in response to the state information request command, a no-response failure alarm is generated by a display and operation section 12.

### [Block Diagram of Fire Alarm System]

Next, a detailed configuration of the fire alarm system is described.

For the purpose of description, FIG. 2 mainly illustrates the fire alarm control panel FA and the audible alarm device C11.

### (Fire Alarm Control Panel)

The fire alarm control panel FA includes a control section 11, the display and operation section 12, the storage section 13, and a transmitting and receiving section 14. The fire alarm control panel FA further includes a battery 15, a power supply circuit 16, and a fuse 17.

The control section 11 controls the operation of the entire system including the display and operation section 12 and the transmitting and receiving section 14 based on control programs stored in advance in the storage section 13.

The display and operation section 12 includes: display means such as a screen and a lamp, for displaying the fire information detected by the terminal equipment or the states of the respective terminal equipment; and operation means such as a touch panel and a button, for operating the fire alarm control panel FA and the respective terminal equipment.

The transmitting and receiving section 14 is controlled by the control section 11 to transmit signals to the respective terminal equipment and receive signals transmitted from the respective terminal equipment.

The storage section 13 stores programs and various data to operate the control section 11.

The battery 15 is one of the power sources for supplying power to the audible alarm device C11 through the power line PG in case of power failure. The power to be supplied from the battery 15 is adjusted to a predetermined voltage value by the power supply circuit 16 and then supplied to the power line PG. When power is not interrupted, power supplied from a commercial electrical outlet or the like (not shown) is adjusted to the predetermined voltage value by the power supply circuit 16 and then supplied to the power line PG.

The fuse 17 protects the fire alarm control panel FA from overcurrent in case of overcurrent.

(Configuration of Audible Alarm Device)

The audible alarm device C11 is connected to the power line PG as well as the signal line SG, and includes a transmitting and receiving circuit 20, a current limiting circuit 22, a capacitor 23, a piezoelectric buzzer sounding circuit 30, and the like.

The transmitting and receiving circuit 20 receives the control signal transmitted from the fire alarm control panel FA through the signal line SG and carries out reception processing of the control signal. Further, the transmitting and receiving circuit 20 transmits a predetermined signal to the fire alarm control panel FA under control of a control circuit 31.

A constant voltage circuit 21 supplies the current limiting circuit 22 with the power obtained through the power line PG as predetermined constant voltage power.

The current limiting circuit 22 is a circuit for limiting a current supplied to the load to a predetermined value.

On the downstream side of the current limiting circuit 22, the capacitor 23 is connected.

Further, the piezoelectric buzzer sounding circuit 30 is connected in parallel to the capacitor 23.

The piezoelectric buzzer sounding circuit 30 includes the control circuit 31, a piezoelectric buzzer 32 and a coil 33 which are connected in parallel, a transistor 35, a resistor 36, and a resistor 37. The transistor 35 and the resistor 36 together constitute current limiting means 34.

The transistor 35 is an NPN transistor and connected in series to the piezoelectric buzzer 32 and the coil 33, which are connected in parallel. The transistor 35 is controlled by the control circuit 31 via the resistor 37 for protecting the transistor 35, and performs on/off operation to switch a current supply period for the piezoelectric buzzer 32 and the coil 33.

The piezoelectric buzzer 32 is formed such that ceramics on which electrodes are formed and a metal plate are bonded to each other, and is a buzzer which makes a sound by the piezoelectric effect caused when applied with a voltage. The piezoelectric buzzer 32 has a unique frequency for resonance (resonant frequency), and changes in pitch and sound pressure level depending on the applied voltage and the applied voltage frequency.

The coil 33 is connected in parallel to the piezoelectric buzzer 32. When the transistor 35 is turned on, an on-state current corresponding to the on-duration period flows through the coil 33 so that energy is accumulated therein. Then, when the transistor 35 is turned off to release the energy accumulated in the coil 33, a boosted voltage due to a counter electromotive voltage higher than the voltage applied to the coil 33 is generated. Using the boosted voltage, the piezoelectric buzzer 32 is applied with a high voltage to be increased in sound pressure level thereof.

The current limiting means 34 includes the transistor 35 and the resistor 36 connected in series to the transistor 35. The resistor 36 is connected to an emitter of the transistor 35, thereby constituting an emitter follower circuit. The current limiting means 34 is capable of fixing a voltage applied to the resistor 36 when the transistor 35 is controlled to turn on, and hence a current flowing through the resistor 36 is limited to a predetermined current value. It is accordingly possible to limit a current flowing through the coil 33 connected in series to the resistor 36 via the transistor 35.

When receiving the control signal for sounding from the fire alarm control panel FA, the control circuit 31 turns on/off the transistor 35 at a predetermined frequency so that the voltage is applied to the coil 33 at the predetermined frequency. Then, the boosted voltage, which is generated in the coil 33 when the transistor 35 is turned off, is applied to the piezoelectric buzzer 32, to thereby sound the piezoelectric buzzer 32.

Here, there are fluctuations in drive frequency of the piezoelectric buzzer 32 for obtaining a maximum sound pressure from one individual to another. It is possible to sound the individual piezoelectric buzzers 32 at the maximum sound pressure through the adjustment to the drive frequencies in accordance with the individual characteristics of the piezoelectric buzzers 32. However, the adjustment at the individual level requires great effort and cost. Besides, temperature conditions in the installation place are also responsible for the change in drive frequency of the piezoelectric buzzer 32 for obtaining a maximum sound pressure. Therefore, the maximum sound pressure is not always obtained through the adjustment.

For that reason, the control circuit 31 sweeps the frequency at which the transistor 35 is turned on/off, that is, the frequency of the voltage to be applied to the piezoelectric buzzer 32, in a predetermined range. For example, a voltage is applied for 10 msec each in 0.1 kHz step, like 2.5 kHz, 2.6 kHz, 2.7 kHz, . . . , 3.5 kHz, and the piezoelectric buzzer 32 is caused to sound at the respective frequencies. By sweeping the frequency of the voltage to be applied in the predetermined range in this way, it is possible to sound the piezoelectric buzzer 32 with the maximum sound pressure level at any of the timings. Note that, the transistor 35 operates as a switch for turning on/off the current limiting means 34 and is also a constituent part of the current limiting means 34, and hence the number of parts may be reduced, which is superior in cost.

### (Operation for Making Sound of Audible Alarm Device)

Description is given of an operation for making a sound of the audible alarm device C11 configured as described above.

When the on/off voltage is applied to the coil 33 by the transistor 35 under control of the control circuit 31, the piezoelectric buzzer 32 makes a sound. As described above, the control circuit 31 sweeps the frequency of the voltage to be applied in a predetermined range, and hence it is possible to sound the piezoelectric buzzer 32 with a maximum sound pressure at any of the timings, irrespective of fluctuations in its unique frequency.

Further, when the voltage is applied to the coil 33, the current flowing therethrough gradually increases but is limited not to exceed a predetermined current value by the current limiting means 34. Note that, taking an error of the coil 33 into consideration, the current limit value to be set by the current limiting means 34 is a value slightly larger than a current value for magnetic flux saturation.

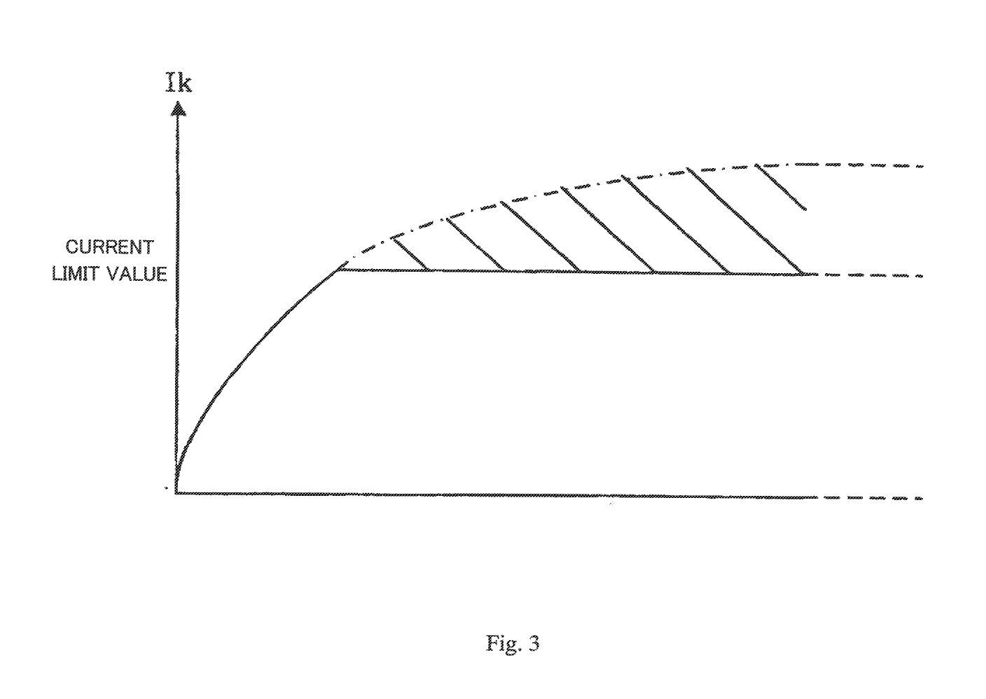

FIG. 3 is a graph schematically illustrating the current limited by the current limiting means 34. In FIG. 3, the solid line represents the current flowing through the coil 33 of the audible alarm device C11 according to the first embodiment, the dashed line represents a current that would flow when the current limiting means 34 is not provided, and the hatched area represents an amount of current eliminated in the first embodiment.

As illustrated in FIG. 3, the current limiting means 34 may limit the current flowing through the coil 33 to a predetermined limit value. In other words, it is possible to prevent wasted current from flowing after the magnetic flux saturation of the coil 33, thereby minimizing a maximum value of the current flowing through the coil 33.

Next, an action of the capacitor 23 is described.

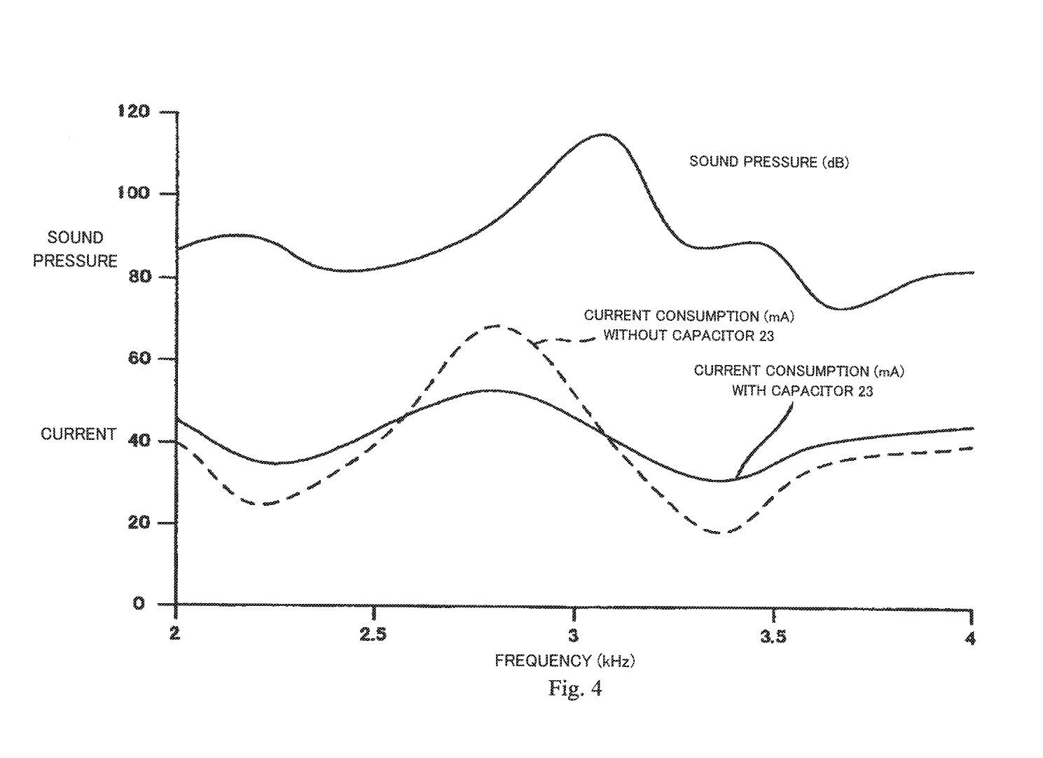

FIG. 4 is a graph illustrating waveforms of the sound pressure level and current consumption of the piezoelectric buzzer 32 when the frequency applied to the piezoelectric buzzer 32 is varied. In FIG. 4, the solid line represents current consumption when the capacitor 23 is provided as in the first embodiment, and the broken line represents current consumption when the capacitor 23 is not provided.

In FIG. 4, attention is now paid to the graph of the sound pressure level of the piezoelectric buzzer 32 and the graph of the conventional current consumption. As illustrated in FIG. 4, when the piezoelectric buzzer 32 is caused to sound at varying frequencies, a peak of the sound pressure level of the piezoelectric buzzer 32 and a peak of the current consumption do not always coincide with each other. In other words, it cannot be said that the increased current accompanying the increase in current consumption always contributes to the increased sound pressure level, and in such a case, wasted current consumption is generated.

The audible alarm device C11 according to the first embodiment includes the capacitor 23, which is connected in parallel to the piezoelectric buzzer sounding circuit 30. Accordingly, when the piezoelectric buzzer sounding circuit 30 consumes a small current, the excess current is accumulated in the capacitor 23. When the piezoelectric buzzer sounding circuit 30 consumes a large current, the current accumulated in the capacitor 23 is discharged. As a result, as illustrated as the solid line of FIG. 4, the peak (maximum value) of the current consumption is suppressed so that the current consumption may be substantially equalized.

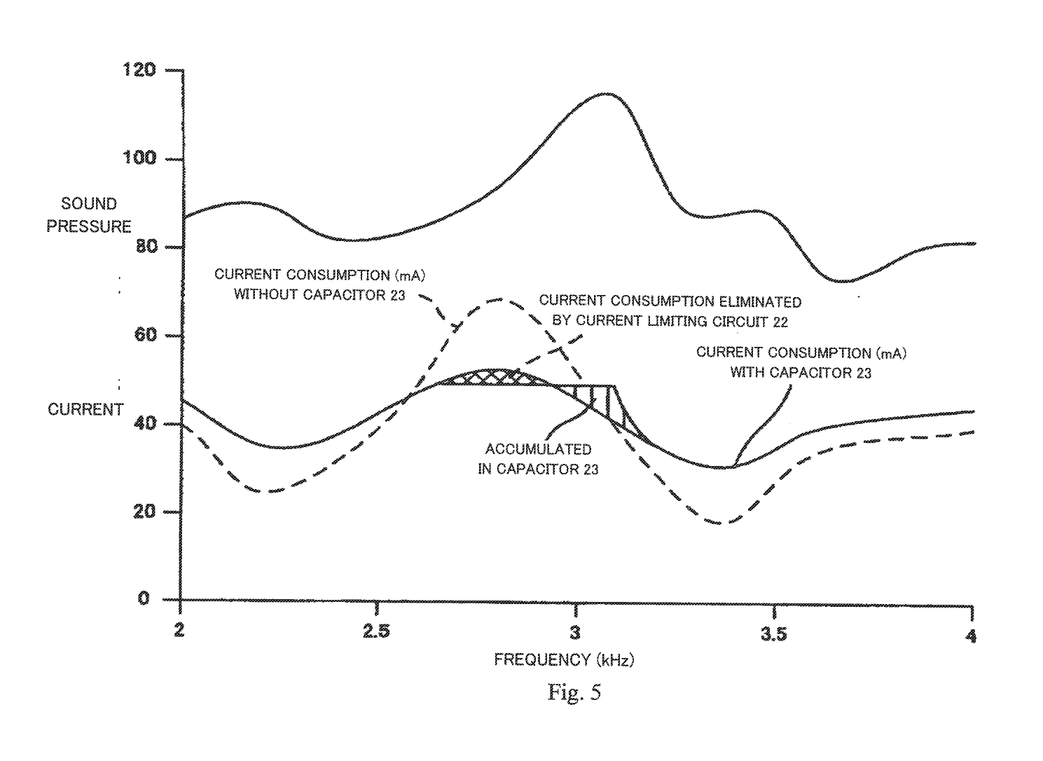

FIG. 5 is a graph illustrating the waveforms of the sound pressure level and the current consumption of the piezoelectric buzzer 32 when the frequency applied to the piezoelectric buzzer 32 is varied, additionally illustrating the effect caused by the current limiting circuit 22 in the same graph of FIG. 4.

As described above, the current limiting circuit 22 limits the current flowing into the load. In other words, as illustrated in FIG. 5, the current limiting circuit 22 suppresses the current consumption in a region represented by “cross” hatching. Therefore, the peak (maximum value) of the current consumption may be suppressed.

Even in a case where the load requires a current which exceeds a given current value limited by the current limiting circuit 22 and also includes the charge current of the capacitor 23, the current limiting circuit 22 limits the current to suppress current supply from the constant voltage circuit 21. Then, a current corresponding to the shortage due to the suppression is supplied from the charged capacitor 23.

As illustrated by “single” hatching of FIG. 5, when the current necessary for the load to make a sound is smaller than the current limited by the current limiting circuit 22, the capacitor 23 is charged. The current limiting circuit 22 is provided mainly for limiting the current when the charge current of the capacitor 23 is large.

As described above, according to the audible alarm device C11 of the first embodiment, the current flowing through the coil 33 may be limited by the current limiting means 34. Further, by the capacitor 23, the peak of the current consumed by the piezoelectric buzzer sounding circuit 30 may be suppressed for equalization. Besides, the current flowing through the piezoelectric buzzer sounding circuit 30 may be limited by the current limiting circuit 22.

In the fire alarm system in which a plurality of the audible alarm devices C11 are connected, more remarkable effects can be obtained.

A possible situation in the fire alarm system illustrated in FIG. 1 is that the plurality of audible alarm devices C11 are connected to the fire alarm control panel FA and the audible alarm devices C11 make sounds intermittently, like “beep, beep, beep”. If the plurality of audible alarm devices C11 make sounds intermittently at different timings, the sounds are difficult for the users to distinguish. For that reason, it is conceivable to synchronize the timings for sounding with one another. In other words, the plurality of audible alarm devices C11 connected in the fire alarm system make sounds at the same timing. Accordingly, the currents consumed at the same timing are increased, and hence it is necessary to increase the power capacity and the capacity of the power supply circuit 16.

However, according to the audible alarm device C11 of the first embodiment, the peak of the current consumption during sounding may be suppressed. Therefore, it is possible to suppress the currents consumed when the plurality of audible alarm devices C11 make sounds at the same timing as a whole, to thereby reduce the capacity of the battery 15 and the power supply circuit 16 in the fire alarm control panel FA so as to reduce the cost.

Further, the capacity of the fuse included in the fire alarm control panel FA may be optimized. Specifically, if the capacity of the fuse 17 is small, the fuse blows out frequently at the peak of current consumption, which makes it difficult to keep stable operation of the fire alarm system. On the other hand, if the capacity of the fuse 17 is large, there is a fear that overcurrent cannot be detected at an intended timing of detecting the overcurrent.

However, in the audible alarm device C11 according to the first embodiment, the current consumption is limited by the current limiting circuit 22, and hence a maximum current consumption per device becomes substantially constant. Conventionally, in the case where the plurality of audible alarm devices C11 are connected, the capacity of a fuse is determined based on the number of the connected devices, taking into consideration of an error of each audible alarm device C11 and an individual difference thereamong to estimate a maximum current consumption per device with a margin. Therefore, it cannot be said that the optimal capacity is always selected. However, according to the audible alarm device C11 of the first embodiment, the maximum current consumption per device is substantially constant, and hence the capacity of the fuse may be optimized. Therefore, the fire alarm control panel FA may be protected appropriately.

Note that, the transistor 35 is formed of an NPN transistor in the first embodiment by way of example, but the transistor 35 may be formed of a PNP transistor instead.

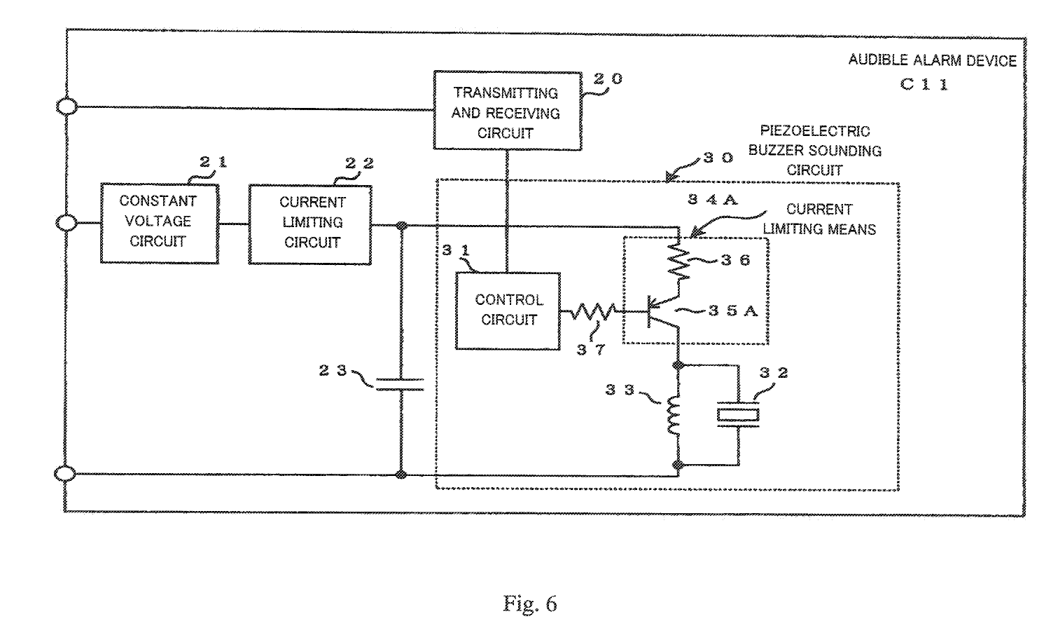

FIG. 6 is a circuit diagram of the audible alarm device C11 when a PNP transistor is used as a transistor 35A.

As illustrated in FIG. 6, the resistor 36 is connected to an emitter of the transistor 35A. The resistor 37 for protecting the transistor 35A is connected to a base of the transistor 35A. The piezoelectric buzzer 32 and the coil 33 are connected in parallel to each other on a side of a collector of the transistor 35A. Current limiting means 34A is constituted by the transistor 35A and the resistor 36.

Also with this configuration, the current limiting means 34A limits the peak of the current flowing through the coil 33, thereby obtaining the same effect as in the case where an NPN transistor is used as the switching means.

In the first embodiment, the switching means, such as a transistor, for adjusting the current supply period for the coil 33, and the current limiting means, such as a current limiting circuit, for limiting the current flowing into the coil 33 are shared by a single component, but alternatively different components may be provided therefor. Even in such a case, the peak current flowing through the coil 33 may be suppressed.

### Second Embodiment

In the above-mentioned first embodiment, the example of sweeping the frequency of the voltage to be applied to the piezoelectric buzzer in a predetermined range has been described. In a second embodiment, the voltage to be applied to the piezoelectric buzzer is further subjected to duty control. Note that, in the second embodiment, the difference from the above-mentioned first embodiment is mainly described, and the same or corresponding components as those of the first embodiment are denoted by the same reference symbols.

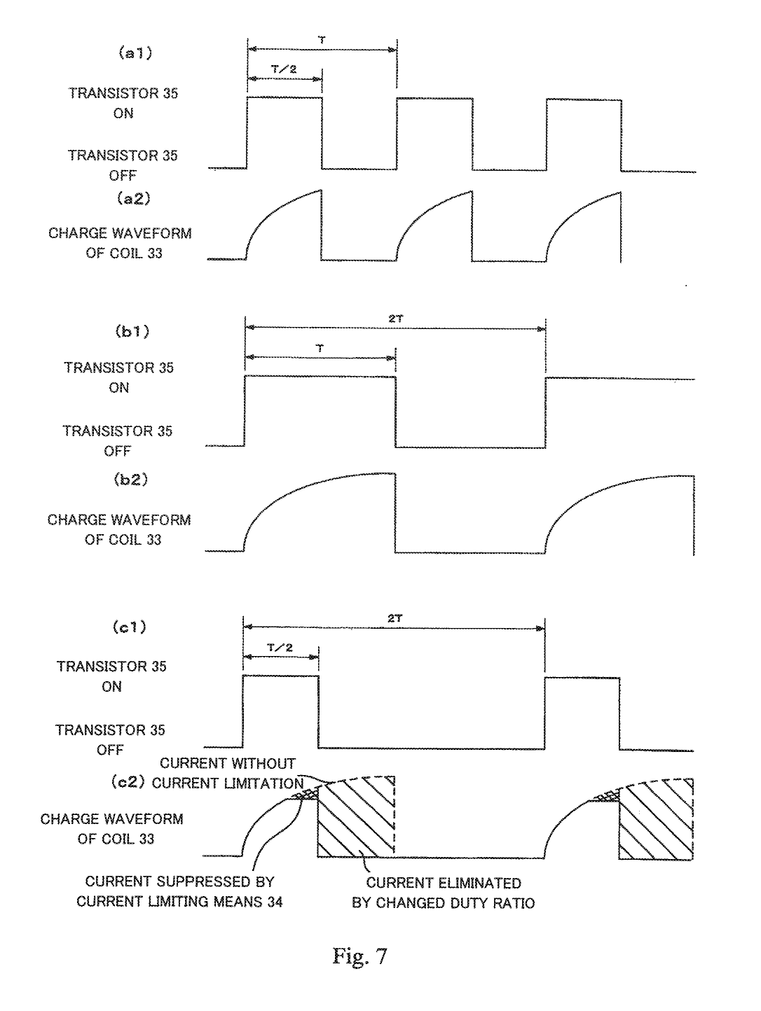

FIG. 7 is a diagram illustrating on/off waveforms of the transistor 35 and charge waveforms of the coil 33 when the frequency of the applied voltage is varied. The parts (a1), (b1), and (e1) of FIG. 7 illustrate the on/off waveforms of the switching means, in which the transistor 35 is turned off when the line is on the downside, and the transistor 35 is turned on when the line is on the upside. The charge current waveforms of the coil 33 corresponding to the parts (a1), (b1), and (e1) are illustrated in the parts (a2), (b2), and (c2), in which a larger current flows through the coil 33 as the line approaches the upside.

When the transistor 35 operates to turn on as illustrated in the part (a1) of FIG. 7, the charge current gradually flows through the coil 33 as illustrated in the part (a2) of FIG. 7. Then, the coil 33 is discharged by the off operation of the transistor 35.

Here, as described above in the first embodiment, for example, the switching means applies a voltage to the coil 33 at frequencies varying in 0.1 kHz step, like 2.5 kHz, 2.6 kHz, 2.7 kHz, . . . , 3.5 kHz.

The part (b1) of FIG. 7 illustrates a waveform when the transistor 35 is switched at a frequency half the frequency in the part (a1) of FIG. 7. As illustrated in FIG. 7, when the switching frequency is halved, a time period for continuously applying a voltage to the coil 33 becomes twice, and the charge current to the coil 33 is also increased. For example, assume that a boosted voltage sufficient to sound the piezoelectric buzzer is obtained with the charge current waveform of the coil 33 illustrated in the part (a2) of FIG. 7. In this case, it can be said that the coil 33 illustrated in the part (b2) of FIG. 7 consumes wasted current.

In view of this, as illustrated in the part (c1) of FIG. 7, a duty ratio of the on/off operation of the switching means is changed. Specifically, the on-time of the switching means is set the same as that in the part (a1) of FIG. 7, and the switching means is turned off until the next on-timing illustrated in the part (b1) of FIG. 7 is reached.

With this configuration, as illustrated in the part (c2) of FIG. 7, the current consumption of the coil 33 may be suppressed. Note that, although illustrated in the part (c2) of FIG. 7, the current limiting effect by the current limiting means 34 as described in the above-mentioned first embodiment can also be obtained.

As described above, according to the audible alarm device of the second embodiment, the duty ratio of the voltage applied to the coil 33 is changed. Therefore, it is possible to suppress the flow of current not contributing to the increase in sound pressure level of the piezoelectric buzzer 32, thereby reducing power consumption.

### Third Embodiment

In the fire alarm system according to the above-mentioned first embodiment, the fire alarm control panel FA and the audible alarm device C11 are connected through the power line PG as well as the signal line SG. In other words, the audible alarm device C11 obtains power for sounding the piezoelectric buzzer 32 through the power line PG.

In a third embodiment, description is given of an example of a fire alarm system in which the signal line SG serves also as a power line. Note that, in the third embodiment, the difference from the above-mentioned first embodiment is mainly described, and the same or corresponding components as those of the first embodiment are denoted by the same reference symbols.

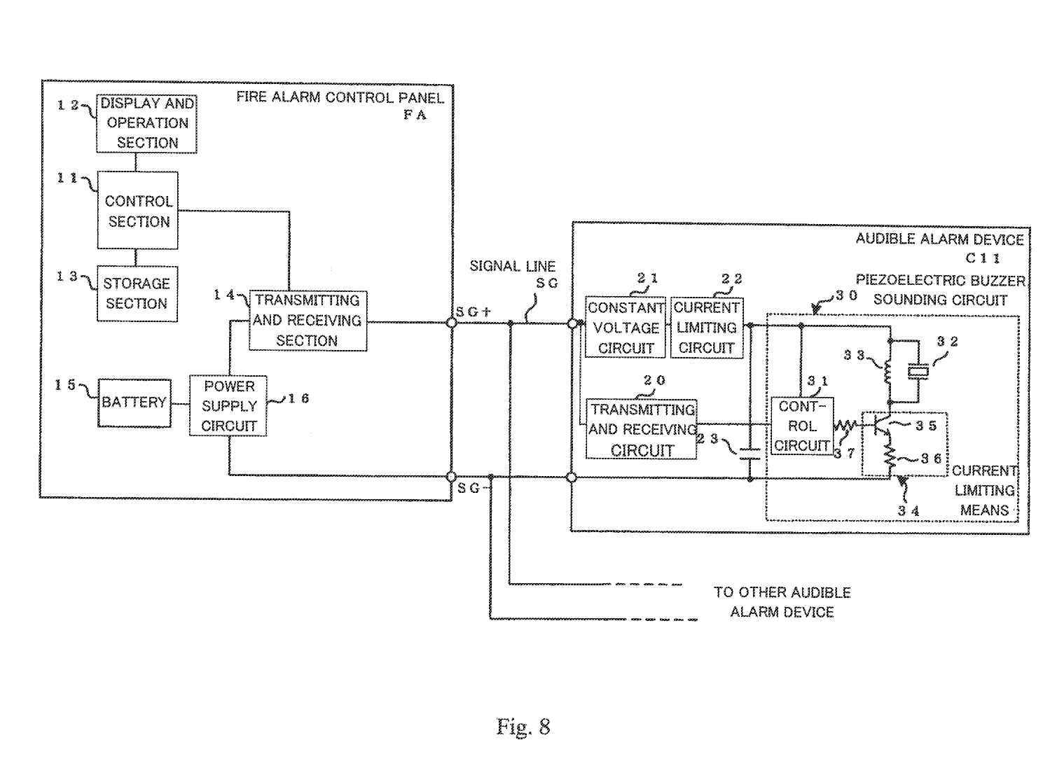

FIG. 8 is a circuit configuration diagram of a fire alarm control panel FA and an audible alarm device C11 in a fire alarm system according to the third embodiment.

As illustrated in FIG. 8, the fire alarm control panel FA and the audible alarm device C11 are connected through the signal line SG serving also as the power line. Unlike FIG. 2 described in the first embodiment, the power supply circuit 16 of the fire alarm control panel FA is connected to the signal line SG, and the constant voltage circuit 21 of the audible alarm device C11 is also connected to the signal line SG. The other circuit configurations of the control circuit 31, the current limiting circuit 22, the capacitor 23, the piezoelectric buzzer 32, the coil 33, and the current limiting means 34 are the same as those of FIG. 2 described above.

Also with this configuration, in which the signal line SG serves as both of the signal line and the power line, similarly to the above-mentioned first embodiment, it is possible to suppress the current consumption required for sounding the audible alarm device C11.

Meanwhile, in general, when a power source and a load are connected to each other through wiring, a voltage reaching the load becomes lower than a voltage applied from the power source because of the wiring resistance. Referring to the example of FIG. 8, the voltage reaching the audible alarm device C11 and other terminal equipment becomes lower than the voltage applied to the signal line SG from the power supply circuit 16 of the fire alarm control panel FA.

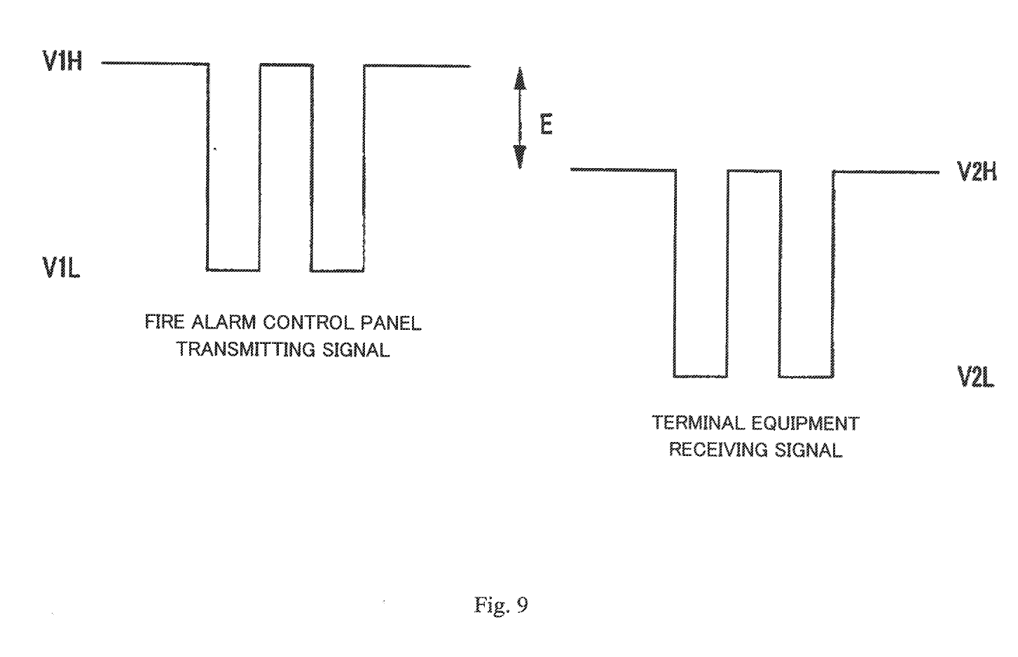

Specific description is given with reference to FIG. 9.

FIG. 9 is a schematic diagram of a pulse signal transmitted by the fire alarm control panel FA and a pulse signal received by the audible alarm device C11 as the terminal equipment.

The fire alarm control panel FA transmits a signal to the audible alarm device C11, specifically a pulse signal which is a combination of a high-level voltage (V1H) and a low-level voltage (V1L).

The signal transmitted from the fire alarm control panel FA is applied to the audible alarm device C11 and other terminal equipment after suffering from voltage drop of E=R×I, where R represents a line resistance of the signal line SG and I represents current consumption of the audible alarm device C11 and other terminal equipment connected to the signal line SG. Therefore, E is larger as the current consumption I is larger.

Then, the audible alarm device C11 and other terminal equipment receive a pulse signal which is a combination of a high-level voltage (V2H) and a low-level voltage (V2L).

If E (difference between the applied voltage on the transmission side and the applied voltage on the reception side) is large, there is a fear that the audible alarm device C11 and other terminal equipment cannot determine the high-level voltage (V2H) as a high-level signal, causing a failure of communication. On the other hand, if the low-level voltage (V2L) reduces, the applied voltage reduces, causing a fear that the audible alarm device C11 and other terminal equipment cannot operate.

Therefore, in particular the case where the signal line SG serves also as the power line as in the third embodiment, it is particularly important to reduce the peak of current consumption of the audible alarm device C11. In other words, by reducing the peak of current consumption, the above-mentioned E (difference between the applied voltage on the transmission side and the applied voltage on the reception side) may be minimized, to thereby suppress the degradation of the signal applied from the fire alarm control panel FA.

Further, E may be minimized by suppressing the peak of current consumption of the audible alarm device C11, and hence it is also possible to extend the distance of the signal line SG or use inexpensive thin wiring (increase wiring resistance). Besides, it is possible to increase the number of connected terminal equipment because the peak of current consumption is reduced.

### Fourth Embodiment

In the above-mentioned first embodiment, the description is given of an example of the case where the audible alarm device according to the present invention is applied to the fire alarm system including the so-called R-type fire alarm control panel. In a fourth embodiment, description is given of an example of the case where the audible alarm device according to the present invention is applied to a fire alarm system including a so-called P-type fire alarm control panel, which receives a fire signal through the flow of electrical current as a result of closing an electrical contact of a fire detector or the like. Note that, in the fourth embodiment, the difference from the above-mentioned first embodiment is mainly described, and the same or corresponding components as those of the first embodiment are denoted by the same reference symbols.

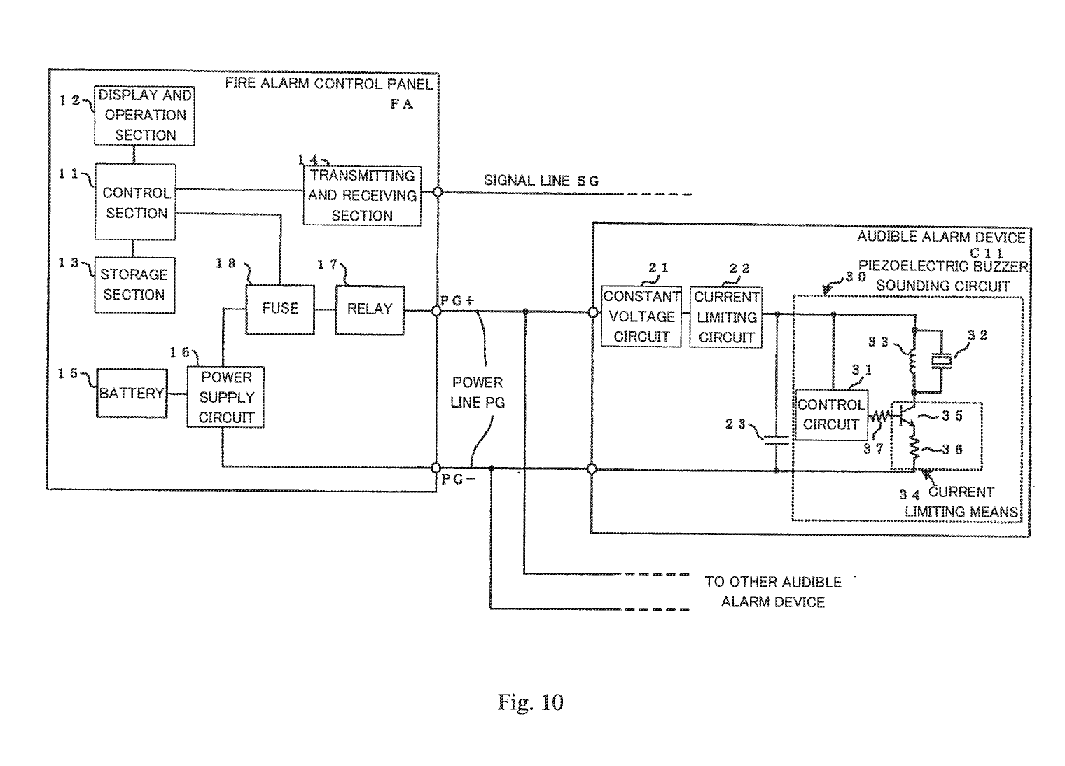

FIG. 10 is a circuit configuration diagram of a fire alarm control panel FA and an audible alarm device C11 in a fire alarm system according to the fourth embodiment.

As illustrated in FIG. 10, the fire alarm control panel FA and the audible alarm device C11 are connected through the power line PG.

The fire alarm control panel FA includes a relay 18 controlled by the control section 11. When receiving a fire signal from other terminal equipment, for example, a fire detector such as a photoelectric detector or a heat detector, which notifies the fire signal using an on/off signal, the fire alarm control panel FA controls the relay 18 so that a voltage is applied to the power line PG from the power supply circuit 16.

The audible alarm device C11 does not include the transmitting and receiving circuit 20 described in the first embodiment, but the other circuit configurations of the control circuit 31, the current limiting circuit 22, the capacitor 23, the piezoelectric buzzer 32, the coil 33, and the current limiting means 34 are the same as those of FIG. 2 described above.

When the voltage is applied to the power line PG, the control circuit 31 of the audible alarm device C11 starts operating to sound the piezoelectric buzzer 32.

Even in the above-mentioned configuration in which the audible alarm device C11 is connected to the so-called P-type fire alarm control panel FA through the power line PG, similarly to the above-mentioned first embodiment, it is possible to suppress the current consumption required for the audible alarm device C11 to make a sound, to thereby reduce the capacity of the battery 15 and the power supply circuit 16 in the fire alarm control panel FA so as to reduce the cost. Besides, the capacity of the fuse may be optimized so that the fire alarm control panel FA may be protected appropriately.

What is claimed is:

1. An audible alarm device, comprising:
a piezoelectric buzzer;
a coil connected in parallel to the piezoelectric buzzer;
switching means for adjusting a current supply period for the piezoelectric buzzer and the coil;
control means for controlling on/off operation of the switching means; and
current limiting means for limiting a current to the coil, the current limiting means being connected in series to the coil and the piezoelectric buzzer, which are connected in parallel.

2. An audible alarm device, comprising:
a piezoelectric buzzer;
a coil connected in parallel to the piezoelectric buzzer;
current limiting means for adjusting a current supply period for the piezoelectric buzzer and the coil, and limiting a current to the coil during current supply; and
control means for controlling on/off operation of the current limiting means.

3. An audible alarm device according to claim 2, wherein the current limiting means comprises an emitter follower circuit comprising a transistor and a resistor connected to an emitter of the transistor.

4. An audible alarm device according to claim 1, wherein the control means varies a frequency of the on/off operation.

5. An audible alarm device according to claim 2, wherein the control means varies a frequency of the on/off operation.

6. An audible alarm device according to claim 4, wherein the control means varies a duty ratio of the on/off operation.

7. An audible alarm device according to claim 5, wherein the control means varies a duty ratio of the on/off operation.

8. An audible alarm device according to claim 6, wherein the control means varies the duty ratio so that on time is kept constant.

9. An audible alarm device according to claim 7, wherein the control means varies the duty ratio so that on time is kept constant.

10. An audible alarm device, comprising:
a piezoelectric buzzer sounding circuit comprising:
a piezoelectric buzzer;
a coil connected in parallel to the piezoelectric buzzer;
switching means for adjusting a current supply period for the piezoelectric buzzer and the coil; and
control means for varying a frequency to control on/off operation of the switching means; and
a capacitor connected in parallel to the piezoelectric buzzer sounding circuit.

11. An audible alarm device according to claim 10, further comprising current limiting means for limiting a current supplied to the piezoelectric buzzer sounding circuit and the capacitor.

12. An audible alarm device according to claim 10, wherein the control means varies a duty ratio of the switching means.

13. An audible alarm device according to claim 10, wherein the control means varies a duty ratio so that the current supply period for the coil is kept constant.

14. A fire alarm system, comprising:
a fire alarm control panel; and
the audible alarm device according to claim 1, which is connected to the fire alarm control panel through a signal line as a path for signal communication,
wherein the audible alarm device makes a sound based on a control signal transmitted from the fire alarm control panel.

15. A fire alarm system, comprising:
a fire alarm control panel; and
the audible alarm device according to claim 2, which is connected to the fire alarm control panel through a signal line as a path for signal communication,
wherein the audible alarm device makes a sound based on a control signal transmitted from the fire alarm control panel.

16. A fire alarm system, comprising:
a fire alarm control panel; and
the audible alarm device according to claim 10, which is connected to the fire alarm control panel through a signal line as a path for signal communication,
wherein the audible alarm device makes a sound based on a control signal transmitted from the fire alarm control panel.

17. A fire alarm system, comprising:
a fire alarm control panel; and
a plurality of the audible alarm devices according to claim 1, which are connected to the fire alarm control panel through a signal line as a path for signal communication,
wherein the plurality of the audible alarm devices make sounds based on a control signal transmitted from the fire alarm control panel, intermittently in synchronization among the plurality of the audible alarm devices.

18. A fire alarm system, comprising:
a fire alarm control panel; and
a plurality of the audible alarm devices according to claim 2, which are connected to the fire alarm control panel through a signal line as a path for signal communication,
wherein the plurality of the audible alarm devices make sounds based on a control signal transmitted from the fire alarm control panel, intermittently in synchronization among the plurality of the audible alarm devices.

19. A fire alarm system, comprising:
a fire alarm control panel; and
a plurality of the audible alarm devices according to claim 10, which are connected to the fire alarm control panel through a signal line as a path for signal communication,
wherein the plurality of the audible alarm devices make sounds based on a control signal transmitted from the fire alarm control panel, intermittently in synchronization among the plurality of the audible alarm devices.
